(19) United States
(12) Patent Application Publication
(10) Pub. No.: US 2023/0014171 A1
(43) Pub. Date: Jan. 19, 2023

(54) HEATER

(71) Applicant: NITTO DENKO CORPORATION, Ibaraki-shi, Osaka (JP)

(72) Inventors: Naoko Kato, Osaka (JP); Takahiro Fujii, Osaka (JP); Yuya Oda, Osaka (JP); Shu Sasaki, Osaka (JP)

(73) Assignee: NITTO DENKO CORPORATION, Ibaraki-shi, Osaka (JP)

(21) Appl. No.: 17/786,229

(22) PCT Filed: Nov. 10, 2020
(86) PCT No.: PCT/JP2020/041868

§ 371 Date: Jun. 16, 2022

(30) Foreign Application Priority Data
Dec. 19, 2019 (JP) 2019-228890

(51) Int. Cl. H05B 3/03; H05B 3/14

(52) U.S. Cl. CPC H05B 3/03; H05B 3/14

(57) ABSTRACT

A heater 1a includes: a substrate 10 made of a resin; a conductive film 20 being a heating element; and a power supply electrode 30. The power supply electrode 30 is electrically connected to the conductive film 20 and is arranged along a surface of the conductive film 20. The power supply electrode 30 includes a conductive filler 30p and a binder 30m. The binder 30m binds the conductive filler 30p. The power supply electrode 30 has a specific resistance of 100 µΩ•cm or less. The heater 1a satisfies a relation |Rd ― Ri|/Ri ≤ 0.2. Rd is an electrical resistance [Ω] of the heater 1a, the electrical resistance being obtained after an environment of the heater 1a is maintained at a temperature of 85° C. and a relative humidity of 85% for 1000 hours. Ri is an initial electrical resistance Ri of the heater 1a.

### TECHNICAL FIELD

The present invention relates to a heater.

### BACKGROUND ART

Heaters including a conductive film as a heating element have been known.

For example, Patent Literature 1 describes a transparent conductive film glass heater. The transparent conductive film glass heater includes a heating member and a power supply member. The heating member is coupled to the power supply member, and the power supply member intermittently supplies power to the heating member. The heating member is formed of a transparent conductive film glass sheet and an insulating film. The transparent conductive film glass sheet is formed by fusing a transparent conductive film with one surface of a glass sheet. An electrode coupled to the transparent conductive film is arranged in each of two side edge portions of the transparent conductive film over the entire length of each side edge portion. The electrode is preferably formed by baking a silver paste at 580 to 680° C.

Patent Literature 2 describes a flexible heater panel. The heater panel includes a transparent substrate, a transparent conductive thin film, and an electrode. A polymer resin such as a polyester resin is used as the material of the transparent substrate. The transparent conductive thin film is a thin metal film or a thin semiconductor film, and the material of the thin semiconductor film can be In₂O₃, SnO₂, or ITO (indium tin oxide). The electrode is arranged at each end portion of the transparent conductive thin film. The electrode is formed, for example, by printing a printable conductive ink. The conductive ink includes, for example, silver particles in an epoxy resin binder.

### CITATION LIST

### Patent Literature

Patent Literature 1: JP 2014-218385 A
Patent Literature 2: US 4952783 A

### SUMMARY OF INVENTION

### Technical Problem

As described in the techniques according to Patent Literatures 1 and 2, it is conceivable that for a heater including a conductive film, a material such as a silver paste or a conductive ink is used to form a power supply electrode. In Patent Literature 1, the transparent conductive film is arranged on one surface of the glass sheet, and the glass sheet is thought to play the role as a substrate of the transparent conductive film. This makes it possible to form the electrode by baking the silver paste at high temperatures (580 to 680° C.).

On the other hand, the technique according to Patent Literature 2 employs a substrate made of a resin. Accordingly, it is hard to accomplish baking of a conductive ink at high temperatures and the electrode is thought to be formed by printing the conductive ink at a relatively low temperature. Patent Literature 2 fails to specifically discuss the durability of the heater panel in a high-temperature and high-humidity environment.

Therefore, the present invention provides a heater including a substrate made of a resin, the heater exhibiting a high durability in a high-temperature and high-humidity environment.

### Solution to Problem

The present invention provides a heater including:
a substrate made of a resin;
a conductive film being a heating element, the conductive film being arranged along a principal surface of the substrate; and
a power supply electrode electrically connected to the conductive film, the power supply electrode being arranged along a surface of the conductive film, wherein
the power supply electrode includes a conductive filler and a binder binding the conductive filler,
the power supply electrode has a specific resistance of 100 µΩ•cm or less, and
an electrical resistance Rd of the heater and an initial electrical resistance Ri of the heater satisfy a relation |Rd - Ril/Ri ≤ 0.2, the electrical resistance Rd being obtained after an environment of the heater is maintained at a temperature of 85° C. and a relative humidity of 85% for 1000 hours.

### Advantageous Effects of Invention

The above heater includes the substrate made of a resin and exhibits a high durability in a high-temperature and high-humidity environment.

### BRIEF DESCRIPTION OF DRAWINGS

FIG. 1 is a plan view showing an example of a heater according to the present invention.

FIG. 2 is a cross-sectional view of the heater along a line II-II of FIG. 1.

FIG. 3 is a cross-sectional view showing an example of a heater-equipped article.

FIG. 4 is a cross-sectional view showing another example of the heater according to the present invention.

### DESCRIPTION OF EMBODIMENTS

A flexible heater can be provided by including a substrate made of a resin in a heater including a conductive film. The value of such a heater can be increased if the heater can exhibit a high durability in a high-temperature and high-humidity environment. A study by the present inventors has revealed that the technique described in Patent Literature 2 leaves room for reexamination in view of increasing the durability of the heater in a high-temperature and high-humidity environment. This is because the resistance value of the whole heater easily varies in a high-temperature and high-humidity environment and that affects the heating performance of the heater. Through a lot of trial and error, the present inventors have found that a power supply electrode including a conductive filler and a binder and having a specific resistance adjusted in a given range is advantageous in increasing the durability of a heater in a high-temperature and high-humidity environment. The present inventors have invented a heater according to the present invention on the basis of this new finding.

Hereinafter, embodiments of the present invention will be described with reference to the drawings. The following description describes examples of the present invention, and the present invention is not limited to the following embodiments.

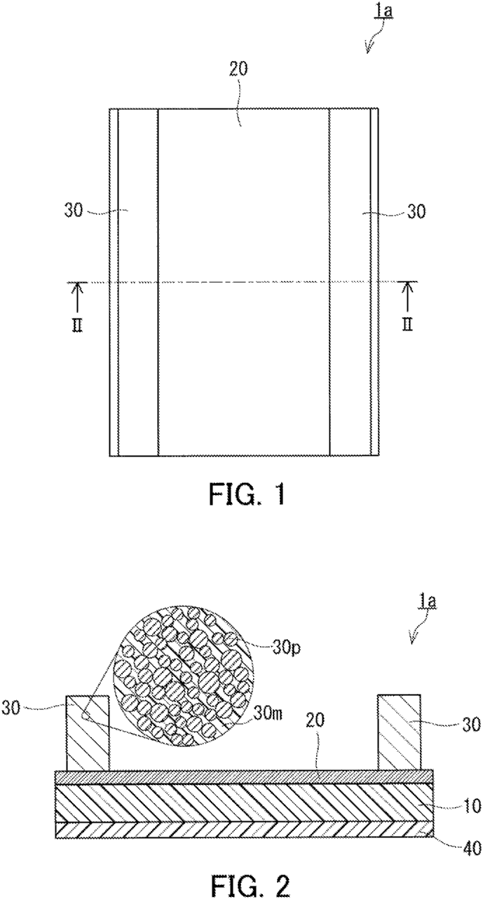

As shown in FIGS. 1 and 2, a heater 1a includes a substrate 10 made of a resin, a conductive film 20 being a heating element, and a power supply electrode 30. The conductive film 20 is arranged along a principal surface of the substrate 10. The power supply electrode 30 is electrically connected to the conductive film 20 in order to apply voltage to the conductive film 20 and is arranged along a surface of the conductive film 20. The power supply electrode 30 includes a conductive filler 30p and a binder 30m. The binder 30m binds the conductive filler 30p. The power supply electrode 30 has a specific resistance of 100 µΩ•cm or less. The heater 1a satisfies a relation |Rd - Ril/Ri ≤ 0.2. Rd is an electrical resistance [Ω] of the heater 1a, the electrical resistance being obtained after an environment of the heater 1a is maintained at a temperature of 85° C. and a relative humidity of 85% for 1000 hours. Ri is an initial electrical resistance Ri of the heater 1a. Herein, the electrical resistance of the heater 1a refers to an overall electrical resistance including an electrical resistance of the power supply electrode 30 itself, an electrical resistance at an interface between the power supply electrode 30 and the conductive film 20, and an electrical resistance of the conductive film 20 itself. The electrical resistance of the heater 1a can be measured, for example, by bringing measurement terminals of a digital multimeter into contact with particular positions of the power supply electrode 30. The value of the initial electrical resistance Ri of the heater 1a may be a value defined in a document, such as a product description or specifications, of the heater 1a.

Since the substrate 10 is made of the resin, the dimensions of the substrate 10 easily changes by exposure of the heater 1a to a high-temperature and high-humidity environment. Meanwhile, since the power supply electrode 30 includes the conductive filler 30p and the binder 30m, stress occurring in the conductive film 20 is likely to be small regardless of a dimensional change of the substrate 10 in a high-temperature and high-humidity environment. As a result, cracking is less likely to occur in the conductive film 20. Moreover, since the power supply electrode 30 includes the conductive filler 30p and the binder 30m, the adhesion between the power supply electrode 30 and a portion having contact with the power supply electrode 30 is likely to be kept high even when the heater 1a is exposed to a high-temperature and high-humidity environment. This can reduce a variation in the electrical resistance of the heater 1a in a high-temperature and high-humidity environment. The portion having contact with the power supply electrode 30 is, for example, the conductive film 20.

The power supply electrode 30 having a specific resistance of 100 µΩ•cm or less can reduce heat generation in the power supply electrode 30 and allows uniform heat generation in the conductive film 20. Moreover, the power supply electrode 30 having a specific resistance of 100 µΩ•cm or less gives the heater 1a an advantage in satisfying the relation |Rd - Ril/Ri ≤ 0.2 and makes it likely that the heater 1a exhibits a high durability in a high-temperature and high-humidity environment.

The specific resistance of the power supply electrode 30 is desirably 80 µΩ•cm or less, more desirably 70 µΩ•cm or less, even more desirably 60 µΩ•cm or less, and particularly desirably 50 µΩ•cm or less.

The heater 1a desirably satisfies a relation |Rd - Ril/Ri ≤ 0.18, and more desirably satisfies a relation |Rd - Ril/Ri ≤ 0.15.

In the heater 1a, the initial electrical resistance Ri is, for example, 100 Ω or less. In this case, the heater 1a is likely to exhibit desirable heating performance.

The initial electrical resistance Ri is desirably 80 Ω or less and more desirably 60 Ω or less. The initial electrical resistance Ri is, for example, 1 Ω or more.

A content of the conductive filler 30p in the power supply electrode 30 is not limited to a particular value. The content of the conductive filler 30p in the power supply electrode 30 is, for example, less than 91 weight%. In this case, the magnitude of stress occurring in the conductive film 20 arranged between the power supply electrode 30 and the substrate 10 is more reliably reduced regardless of a dimensional change of the substrate 10 in a high-temperature and high-humidity environment. Additionally, in this case, the adhesion between the power supply electrode 30 and the portion having contact with the power supply electrode 30 is more reliably kept high even when the heater 1a is exposed to a high-temperature and high-humidity environment. Consequently, the heater 1a more reliably exhibits high durability in a high-temperature and high-humidity environment.

The content of the conductive filler 30p in the power supply electrode 30 is desirably 90.5 weight% or less and more desirably 90.0 weight% or less. The content of the conductive filler 30p in the power supply electrode 30 is, for example, 60 weight% or more.

The binder 30m typically includes a resin. The resin included in the binder 30m is not limited to a particular resin. The binder 30m includes, for example, a polyester resin. In this case, the heater 1a more reliably exhibits high durability even when exposed to a high-temperature and high-humidity environment. The polyester resin desirably includes an aromatic polyester.

The material of the conductive filler 30p is not limited to a particular material. The conductive filler 30p typically includes a metal or a metal compound. The conductive filler 30p desirably includes silver or a silver compound. A given coating may be provided on the conductive filler 30p. For example, a coating may be provided on the conductive filler 30p for better affinity to the binder 30m.

The size of the conductive filler 30p is not limited to a particular value. The average particle diameter of the conductive filler 30p is, for example, 0.01 µm or more, and may be 0.1 µm or more or 0.5 µm or more. The average particle diameter of the conductive filler 30p is, for example, 10 µm or less, and may be 5 µm or less or 2 µm or less. The average particle diameter of the conductive filler 30p can be determined, for example, by the following method. For example, a thin specimen produced from the power supply electrode 30 is observed using a transmission electron microscope, maximum diameters of 50 or more conductive fillers 30p are determined, and the arithmetic average of the maximum diameters is determined as the average particle diameter of the conductive filler 30p.

The shape of the conductive filler 30p is not limited to a particular shape. The shape of the conductive filler 30p may be spherical, fibrous, or flaky. The conductive filler 30p may have an undefined shape.

The material of the conductive film 20 is not limited to a particular material as long as the conductive film 20 functions as a heating element in the heater 1a. The conductive film 20 includes, for example, at least one of a metal and a metal compound. This makes it easy for the heater 1a to achieve a desirable output.

The metal included in the conductive film 20 is not limited to a particular metal. The metal included in the conductive film 20 is, for example, at least one selected from the group consisting of copper, nickel, chromium, palladium, lead, platinum, gold, and silver. The metal compound included in the conductive film 20 is not limited to a particular metal compound. The metal compound included in the conductive film 20 is, for example, a metal oxide or a metal nitride.

The conductive film 20 is transparent, for example, to light with a given wavelength λₚ that is a wavelength of 910 nm or more. In this case, the heater 1a is applicable to an apparatus or system in which light with the wavelength λₚ is used for communication or sensing. The phrase “transparent to light with a given wavelength λp” as used herein refers to having a transmittance of 60% or more at the wavelength λₚ.

The conductive film 20 desirably includes indium oxide. In this case, the conductive film 20 is likely to have a low specific resistance. The conductive film 20 may include indium oxide as its main component. The term “main component” as used herein refers to a component whose content is highest on a mass basis.

The conductive film 20 may include a polycrystal. This is advantageous in providing the conductive film 20 with the desirable properties. For example, when the conductive film 20 is a polycrystal, the conductive film 20 is likely to have a low specific resistance.

The conductive film 20 desirably includes indium tin oxide (ITO). In this case, the content of tin oxide in ITO is, for example, 4 to 14 mass% and desirably 5 to 13 mass%. The ITO included in the conductive film 20 desirably has a polycrystal structure. This is advantageous in keeping the specific resistance of the conductive film 20 low.

The conductive film 20 may be a single-layer film or a multilayer film such as an IAI film in which a silver layer is disposed between two indium zinc oxide (IZO) layers.

The thickness of the conductive film 20 is not limited to a particular thickness. Typically, the thickness of the conductive film 20 is smaller than the thickness of the power supply electrode 30. The thickness of the conductive film 20 is, for example, 20 to 200 nm. In this case, the heater 1a can exhibit favorable temperature rise performance and occurrence of cracking in the conductive film 20 can be reduced. The thickness of the conductive film 20 is desirably 25 to 190 nm and more desirably 30 to 180 nm.

As shown in FIGS. 1 and 2, the heater 1a includes, for example, a pair of the power supply electrodes 30. The pair of power supply electrodes 30 extends, for example, parallel with each other in a longitudinal direction. The pair of power supply electrodes 30 is disposed, for example, on a pair of edge portions of the conductive film 20 along a surface of the conductive film 20, the edge portions being defined in a direction perpendicular to the longitudinal direction. For example, a given voltage is applied to the pair of power supply electrodes 30 to cause the conductive film 20 to generate heat. The electrical resistance of the heater 1a can be measured, for example, by bringing measurement terminals of a digital multimeter into contact with particular positions of the pair of power supply electrodes 30.

The substrate 10 has transparency, for example, to light with a given wavelength, such as visible light or near-infrared light. The thickness of the substrate 10 is not limited to a particular thickness. The thickness of the substrate 10 is, for example, 10 to 200 µm in view of the transparency, strength, and ease of handling. The thickness of the substrate 10 may be 20 to 180 µm or 30 to 160 µm.

The material of the substrate 10 is not limited to a particular resin. The resin included in the substrate 10 is, for example, at least one selected from the group consisting of polyethylene terephthalate, polyethylene naphthalate, polyimides, polycarbonate, polyetheretherketone, and aromatic polyamides.

The principal surface of the substrate 10 may be covered, for example, by an intermediate layer. The intermediate layer includes, for example, an organic polymer forming a cured product and inorganic substance particles dispersed in the cured product. In this case, the adhesion of the conductive film 20 to the substrate 10 is likely to be high.

The power supply electrode 30 has a thickness of, for example, 10 µm or more. In this case, the heater 1a is likely to generate heat at a high temperature rise rate. The thickness of the power supply electrode 30 is a dimension of the power supply electrode 30 in a thickness direction of the conductive film 20.

The thickness of the power supply electrode 30 may be 10 µm or more, 20 µm or more, or 50 µm or more. The thickness of the power supply electrode 30 is, for example, 5 mm or less, and may be 1 mm or less or 700 µm or less.

The width of the power supply electrode 30 is not limited to a particular value. The width of the power supply electrode 30 is, for example, 0.5 to 50 mm. In this case, the heater 1a is likely to generate heat at a high temperature rise rate. The width of the power supply electrode 30 may be 1 mm or more, 10 mm or more, or 20 mm or more. The width of the power supply electrode 30 may be 40 mm or less or 35 mm or less.

As shown in FIG. 2, the heater 1a further includes an adhesive layer 40. In the heater 1a, the substrate 10 is located between the conductive film 20 and the adhesive layer 40 in a thickness direction of the substrate 10. This makes it possible to attach the heater 1a to a given article by pressing the adhesive layer 40 on the article.

The adhesive layer 40 typically includes an adhesive. The adhesive layer 40 may be formed of a single layer or a laminate of a plurality of layers. The adhesive layer 40 that is a laminate of a plurality of layers, for example, may have a structure composed of a given substrate and a pair of adhesive layers separately arranged on each face of the substrate. The adhesive included in the adhesive layer 40 can be a known adhesive such as an acrylic adhesive, a rubber adhesive, and a silicone adhesive.

An example of the method for manufacturing the heater 1a will be described. The conductive film 20 is formed, for example, by sputtering. The conductive film 20 is obtained desirably by performing sputtering using a given target material to form a thin film derived from the target material on a principal surface of the substrate 10. The thin film derived from the target material is formed on the principal surface of the substrate 10 more desirably by high magnetic field DC magnetron sputtering. In this case, the conductive film 20 can be formed at low temperatures. Accordingly, for example, even when the heat resistant temperature of the substrate 10 is not high, the conductive film 20 can be formed on the principal surface of the substrate 10. In addition, defects are less likely to occur in the conductive film 20, and thus a low internal stress of the conductive film 20 can be achieved easily. By adjusting the conditions for sputtering, a thin film that is desirable as the conductive film 20 can be formed easily. The conductive film 20 that is a multilayer film, for example, can be formed by performing sputtering using different target materials under conditions suitable for each target material. When a principal surface of the substrate 10 is covered by the above-described intermediate layer, for example, the conductive film 20 is formed on the intermediate layer.

The thin film formed on the principal surface of the substrate 10 is subjected to annealing treatment, if necessary. For example, the thin film is placed in the air at 120° C. to 150° C. for 1 to 3 hours for annealing treatment. This facilitates crystallization of the thin film, and thus the conductive film 20 that is a polycrystal is formed advantageously. When the temperature of the environment in which the annealing treatment of the thin film is performed and the time period for performing the annealing treatment are within the above ranges, the heat resistant temperature of the substrate 10 need not necessarily be high, and the resin can be used as the material of the substrate 10. In addition, defects are less likely to occur in the conductive film 20, and thus a low internal stress of the conductive film 20 can be achieved more easily. By adjusting the conditions for the annealing treatment, the conductive film 20 desirable in terms of specific resistance can be obtained easily.

The conductive film 20 may be formed not by sputtering but by another technique such as vacuum deposition or ion plating.

The method for forming the power supply electrode 30 is not limited to a particular method. For example, a composition including raw materials of the conductive filler 30p and the binder 30m is formed in a given shape on the conductive film 20 by a technique such as application using a dispenser or screen printing. The composition in the given shape is, if necessary, subjected to treatment such as heating to cure the composition. The power supply electrode 30 can be formed in this manner.

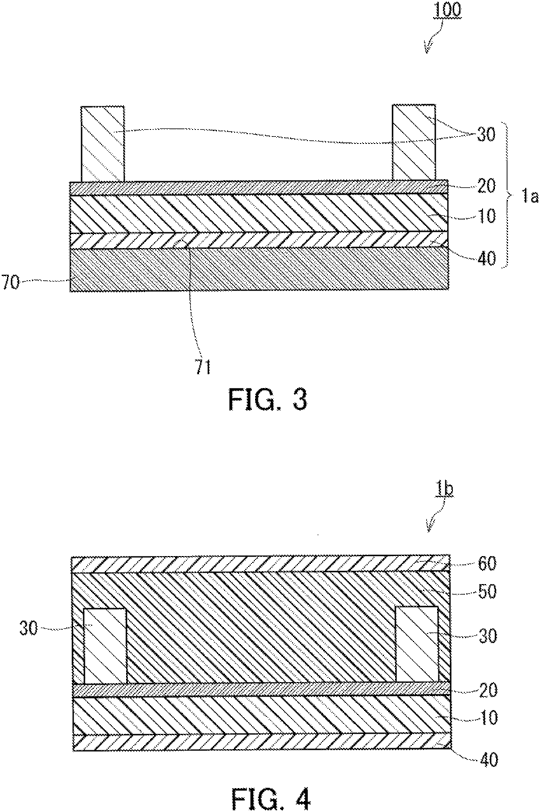

For example, a heater-equipped article 100 as shown in FIG. 3 can be provided using the heater 1a. As shown in FIG. 3, the heater-equipped article 100 includes an article 70 and the heater 1a. The article 70 has an adherend surface 71. The article 70 is formed, for example, of a metal material, a ceramic material, a glass, or a resin. The adhesive layer 40 is in contact with the adherend surface 71.

The adhesive layer 40 may be covered by a release liner (not shown). In this case, the release liner is removed to expose the adhesive layer 40 for the purpose of attaching the heater 1a to the article 70. The release liner is, for example, a film made of a polyester resin such as polyethylene terephthalate (PET).

In an apparatus or system performing a processing using light with the wavelength λₚ, the heater 1a is disposed, for example, on an optical path of the light with the wavelength λₚ. The apparatus or system performs, for example, a given processing, such as sensing or communication, using the light with the wavelength λₚ. The article 70 forms, for example, a housing of such an apparatus.

The heater 1a can be modified in various respects. For example, the heater 1a may be modified to a heater 1b shown in FIG. 4. The heater 1b is configured in the same manner as the heater 1a unless otherwise described. The components of the heater 1b that are the same as or correspond to the components of the heater 1a are denoted by the same reference characters, and detailed descriptions of such components are omitted.

As shown in FIG. 4, the heater 1b further includes a protective layer 50. The protective layer 50 is disposed such that the conductive film 20 is located between the protective layer 50 and the substrate 10. The protective layer 50 covers, for example, at least a portion of the surface of the conductive film 20. Additionally, at least a portion of the power supply electrode 30 is encapsulated in the protective layer 50. The protective layer 50 protects the conductive film 20 and the power supply electrode 30, providing a high impact resistance to the heater 1b.

The material of the protective layer 50 is not limited to a particular material. The material of the protective layer 50 includes, for example, a given organic polymer. The protective layer 50 is formed, for example, of a cured product of a liquid composition cured by treatment such as irradiation of an active energy ray, such as an ultraviolet ray, or heating.

The heater 1b further includes, for example, a protective film 60. The protective film 60 is disposed such that the protective layer 50 is located between the protective film 60 and the conductive film 20. The protective film 60 has, for example, an antireflection function. The protective film 60 prevents, for example, reflection of light with the wavelength Aₚ. The protective film 60 can therefore enhance the reliability of an apparatus or system performing a processing using the light with the wavelength λₚ. The protective film 60 is, for example, in contact with a surface of the protective layer 50. The material of the protective film 60 is not limited to a particular material. The protective film 60 includes, for example, a substrate made of a given resin such as PET and an antireflection coating arranged on the substrate. The antireflection coating is, for example, a laminate in which substances having different refractive indices are alternately laminated.

### EXAMPLES

The present invention will be described in more detail by examples. The present invention is not limited to the examples given below. First, methods for evaluating samples according to Examples and Comparative Examples will be described.

### Specific Resistance of Power Supply Electrode

Conductive pastes used in production of samples according to Examples and Comparative Examples were each applied onto a dielectric substrate to a thickness of 1 mm and a length of 500 mm using a dispenser. The applied conductive paste was heated in a 150° C. environment for 240 minutes to cure the paste. A cured product of the conductive paste was obtained in this manner. Measurement terminals of a digital multimeter CD732 manufactured by SANWA ELECTRIC INSTRUMENT CO., LTD. were brought into contact with the cured product at two positions which were L [cm] apart from each other in a longitudinal direction of the cured product to measure an electrical resistance Rn [µΩ] of the cured product in the longitudinal direction of the cured product. This measurement was carried out in an about 25° C. environment. A cross-section of the cured product was observed using an optical microscope to determine area Sd [cm²] of the cross-section, the cross-section being perpendicular to the longitudinal direction, the cross-section being obtained between the two positions of the cured product with which the measurement terminals of the digital multimeter CD732 had been in contact. Between the two positions, the cured product was able to be considered to have fixed cross-sectional area perpendicular to the longitudinal direction. A value of Rn•Sd/L was calculated, and a specific resistance of the cured product of the conductive paste was determined. Thus-determined specific resistances of the cured products of the conductive pastes are able to be considered specific resistances of power supply electrodes of the samples according to Examples and Comparative Examples. Table 1 shows the results.

### Humidity and Heat Test

The samples according to Examples and Comparative Examples were placed in an environment at a temperature of 85° C. and a relative humidity of 85% for 1000 hours to carry out a humidity and heat test. Before the humidity and heat test, measurement terminals of a digital multimeter CD732 were brought into contact with the pairs of power supply electrodes of the samples according to Examples and Comparative Examples to measure the initial electrical resistance Ri of each sample. Furthermore, after the humidity and heat test, measurement terminals of a digital multimeter CD732 were brought into contact with the pairs of power supply electrodes of the samples according to Examples and Comparative Examples to measure the electrical resistance Rd of each sample having undergone the humidity and heat test. The measurements were carried out in an about 25° C. environment. Table 1 shows the electrical resistances Ri and values of |Rd - Ril/Ri of the samples.

### Heat Generation Test

Temperature distribution on a surface of each of the samples according to Examples and Comparative Examples was measured by thermography while a voltage of 14 V was being applied to the power supply electrodes of the sample in an about 25° C. environment. The measurement results were evaluated according to the following criteria. Table 1 shows the results.
A: The temperature is low around the power supply electrodes compared to the average temperature of a surface of a transparent conductive film.
X: The temperature is high around the power supply electrodes compared to the average temperature of a surface of a transparent conductive film.

### Method for Analyzing Resin Type

The types of resins included in the conductive pastes used in production of the samples according to Examples and Comparative Examples were determined by the following method. First, chloroform was added to a given amount of each conductive paste, and ultracentrifugation was performed. A component soluble in chloroform and a component insoluble in chloroform were thereby separated. The obtained component soluble in chloroform was dried by nitrogen purge. Next, methanol was added to the dried product of the component soluble in chloroform, and a component soluble in methanol and a component insoluble in methanol were separated. After that, the component insoluble in methanol in the dried product of the component soluble in chloroform was dried by nitrogen purge to obtain a dried product. The dried product was used as a specimen for Fourier-transform infrared (FT-IR) spectroscopy, and measurement results were obtained. The measurement was carried out under the following conditions.
Analyzer: Fourier-transform infrared spectrometer Nicolet iS10 FT-IR manufactured by Fisher Scientific K. K.
Measurement method: single-reflection attenuated total reflection (ATR) (diamond 45°, SmartiTR)
Resolution: 4 cm⁻¹
Detector: DTGS detector
Number of integrations: 64 times

### Example 1

An ITO film was formed on one principal surface of a 125 µm thick polyethylene naphthalate (PEN) film by DC magnetron sputtering using indium tin oxide (ITO) (tin oxide content: 10 weight%) as a target material in a high magnetic field with the magnetic flux density of the horizontal magnetic field on a surface of the target material being 80 to 150 mT (millitesla) and in the presence of an inert gas. The PEN film with the ITO film formed thereon was placed in the air at 150° C. for 3 hours for annealing treatment. The ITO was thereby crystallized to form a transparent conductive film.

The thickness of the transparent conductive film was measured by an X-ray reflectivity using an X-ray diffractometer (manufactured by Rigaku Corporation; product name: RINT2200). According to the measurement result, the transparent conductive film had a thickness of 50 nm. Moreover, an X-ray diffraction pattern of the transparent conductive film was obtained using the X-ray diffractometer. CuKα radiation was used as the X-ray. It was confirmed from the obtained X-ray diffraction pattern that the transparent conductive film (heating element) had a polycrystalline structure.

Next, the PEN film on which the transparent conductive film was arranged was cut into a strip. A conductive paste DW117 manufactured by TOYOBO CO., LTD. was applied onto the transparent conductive film using a dispenser to form a pair of strips made of the conductive paste and extending in parallel with each other. Subsequently, the strips of the conductive paste was heated in a 150° C. environment for 240 minutes to cure the conductive paste. A pair of power supply electrodes was formed in this manner. A sample according to Example 1 was produced in this manner. The distance between the pair of power supply electrodes was 20 mm. Each power supply electrode had a width of about 1 mm and a thickness of 120 µm. The conductive paste DW117 includes silver as a conductive filler, and the content of the conductive filler in the conductive paste was 89 weight%. Additionally, according to the result of FT-IR measurement, the conductive paste DW117 included, as a binder, a polyester resin including an aromatic polyester.

### Example 2

A sample according to Example 2 was produced in the same manner as in Example 1, except that a conductive paste DW 351 manufactured by TOYOBO CO., LTD. was used instead of the conductive paste DW117. The distance between the pair of power supply electrodes was 20 mm. Each power supply electrode had a width of about 1 mm and a thickness of 120 µm. The conductive paste DW351 includes silver as a conductive filler, and the content of the conductive filler in the conductive paste was 86 weight%. Additionally, according to the result of FT-IR measurement, the conductive paste DW351 included, as a binder, a polyester resin including an aromatic polyester.

### Comparative Example 1

A sample according to Comparative Example 1 was produced in the same manner as in Example 1, except that a conductive paste EC242 manufactured by Mitsuboshi Belting Ltd. was used instead of the conductive paste DW117. The distance between the pair of power supply electrodes was 20 mm. Each power supply electrode had a width of about 1 mm and a thickness of 120 µm. The conductive paste EC242 includes silver as a conductive filler, and the content of the conductive filler in the conductive paste was 88 weight%. Additionally, according to the result of FT-IR measurement, the conductive paste EC242 included a polyester resin as a binder.

### Comparative Example 2

A sample according to Comparative Example 2 was produced in the same manner as in Example 1, except that a conductive paste EC295B manufactured by Mitsuboshi Belting Ltd. was used instead of the conductive paste DW117. The distance between the pair of power supply electrodes was 20 mm. Each power supply electrode had a width of about 1 mm and a thickness of 120 µm. The conductive paste EC295B includes silver as a conductive filler, and the content of the conductive filler in the conductive paste was 91 weight%. Additionally, according to the result of FT-IR measurement, the conductive paste EC295B included a urethane resin as a binder.

As shown in Table 1, the power supply electrodes of the samples according to Examples 1 and 2 have a specific resistance of 100 µΩ•cm or less, while the power supply electrodes of the sample according to Comparative Example 1 have a specific resistance of more than 100 µm•cm. Comparison of Examples 1 and 2 with Comparative Example 1 indicates that the power supply electrode having a specific resistance of 100 µΩ•cm or less is advantageous in increasing the durability of the heater in a high-temperature and high humidity environment. Comparison of Examples 1 and 2 with Comparative Example 2 indicates that including a polyester resin in the binder of the power supply electrode is advantageous in increasing the durability of the heater in a high-temperature and high-humidity environment.

Table 1

| | | | | | |
|---|---|---|---|---|---|
| | | Example 1 | Example 2 | Comparative Example 1 | Comparative Example 2 |
| Power supply electrode | Binder | Polyester resin | Polyester resin | Polyester resin | Urethane resin |
| | Content of conductive filler (silver) [weight%] | 89 | 86 | 88 | 91 |
| Specific resistance [µΩ•cm] | | 45 | 38 | 117 | 20 |
| Initial resistance Ri [Ω] | | 10 | 10 | 12 | 9 |
| \|Rd - Ri\|/Ri | | 0.12 | 0.12 | 0.43 | 0.22 |
| Heat generation test | | A | A | X | A |

1. A heater comprising:
a substrate made of a resin;
a conductive film being a heating element, the conductive film being arranged along a principal surface of the substrate; and
a power supply electrode electrically connected to the conductive film, the power supply electrode being arranged along a surface of the conductive film, wherein
the power supply electrode includes a conductive filler and a binder binding the conductive filler,
the power supply electrode has a specific resistance of 100 µΩ•cm or less, and
an electrical resistance Rd of the heater and an initial electrical resistance Ri of the heater satisfy a relation |Rd - Ri|/Ri ≤ 0.2, the electrical resistance Rd being obtained after an environment of the heater is maintained at a temperature of 85° C. and a relative humidity of 85% for 1000 hours.

2. The heater according to claim 1, wherein the initial electrical resistance Ri is 100 Ω or less.

3. The heater according to claim 1, wherein a content of the conductive filler in the power supply electrode is less than 91 weight%.

4. The heater according to claim 1, wherein the binder includes a polyester resin.

5. The heater according to claim 1, wherein the conductive filler includes silver or a silver compound.

6. The heater according to claim 1, wherein the conductive film includes indium oxide.

7. The heater according to claim 1, further comprising an adhesive layer, wherein
the substrate is located between the conductive film and the adhesive layer in a thickness direction of the substrate.
